(19) United States
(12) Patent Application Publication
(10) Pub. No.: US 2016/0315347 A1
(43) Pub. Date: Oct. 27, 2016

(54) COMPOSITION FOR HIGHLY CONDUCTIVE POLYMER ELECTROLYTES

(71) Applicants: Qingshan NIU, Shanghai (CN); DOW GLOBAL TECHNOLOGIES LLC, Midland, MI (US)

(72) Inventors: Wei Li, Shanghai (CN); Jianping Xu, Shanghai (CN); Yang Li, Shanghai (CN); Qingshan Niu, Shandong Province (CN); Ling Yuan, Shanghai (CN); Deidre A. Strand, San Diego, CA (US); Douglas A. Brune, Midland, MI (US)

(21) Appl. No.: 15/102,726

(22) PCT Filed: Dec. 11, 2013
(86) PCT No.: PCT/CN2013/089112

§ 371 Date: Jun. 8, 2016

(51) Int. Cl. H01M 10/0565; H01M 10/0525; C08L 87/00; C08G 81/02; C08L 71/02

(52) U.S. Cl. CPC H01M 10/0565; C08G 81/025; C08L 71/02; C08L 87/005; H01M 10/0525; C08L 2203/20; H01M 2300/0082

(57) ABSTRACT

The present invention is directed to a composition containing a block copolymer, a metal ion and a cross-linked polymer comprising polyalkoxide. The composition has increased ion conductivity as well as mechanical strength. The composition is useful for a solid polymer electrolyte of a secondary battery.

### FIELD OF THE INVENTION

The present invention is directed to a composition useful for a polymer electrolyte of a secondary battery. More particularly, the present invention relates to a composition comprising a block copolymer and a cross-linked polymer comprising a polyalkoxide, which increases ion conductivity of a polymer electrolyte as well as its mechanical strength.

### BACKGROUND OF THE INVENTION

Secondary batteries have been used as energy storage and power supply devices since the 1990s, especially for portable devices, like cell phones, notebook computers and power tools. Lithium ion batteries are widely used as secondary batteries because of their high energy density. The traditional lithium ion battery comprises a liquid electrolyte having lithium salts dissolved in an organic solvent, such as polar and aprotic carbonates.

However, the liquid electrolyte poses a risk of leaking of the organic solvent, which may result in explosions or fires. To address these problems, solid electrolyte has been developed as a possible alternative.

There are two types of solid polymer electrolyte, dry solid polymer electrolyte and gel polymer electrolyte. Dry solid polymer electrolyte has advantages like easy processing, low cost and flexible cell configuration, but its low ion conductivity makes it impractical.

In contrast to dry solid polymer electrolyte, gel polymer electrolyte has adequate ion conductivity, but its low mechanical strength is hindrance to a practical use. Therefore, it is highly desirable to develop a solid polymer electrolyte with both high ion conductivity and sufficient mechanical strength.

Many gel polymer electrolytes has been studied including polyalkylene oxide, polyvinylidene fluoride, polyacrylonitrile and polymethylmethacrylate based materials. A block copolymer comprising alkylene oxide chain is disclosed in U.S. Pat. No. 5,219,681; U.S. Pat. No. 5,424,150; U.S. Pat. No. 7,557,166 and US2012/0189910A. US2012/0189910A discloses the use of a block copolymer having two phases, a hard phase and an ion conductive phase. The ion conductive phase was formed by polyalkylene oxide which provides satisfactory ion conductivity, as well as the hard phase works as a skeleton structure of the block copolymer which contributes high mechanical strength.

Inventors of this invention studied many kinds of chemicals and formulation to get more increased ion conductivity of an electrolyte comprising a block copolymer as well as mechanical strength. Then, the inventors developed a more improved composition used for an electrolyte which has both higher ion conductivity and higher mechanical strength.

### SUMMARY OF THE INVENTION

The inventors of this invention have found that adding a cross-linked polymer comprising a polyalkoxide in a composition comprising a block copolymer, can increase both its ion conductivity and mechanical strength. The cross-linked polymer is formed from cross-linkable compounds having polyalkoxide. The cross-link is formed after the compounds are mixed with the block copolymer.

### DETAILED DESCRIPTION OF THE INVENTION

As used throughout this specification, the abbreviations given below have the following meanings, unless the context clearly indicates otherwise: Mw=weight average molecular weight; EO=ethylene oxide; PO=propylene oxide; wt %=weight percent; g=gram; mg=milligram; mm=millimeter; μm=micrometer; min.=minute(s); s=second(s); hr.=hour(s); ° C.=degree Centigrade; S/cm=Siemens per centimeter; Pa=Pascal. Throughout this specification, the words “polyalkylene oxide”, “polyalkoxide” and “poly alkylene glycol” are used interchangeably. Throughout this specification, the words “ethylene oxide” and “ethylene glycol” are used interchangeably as well as the words “propylene oxide” and “propylene glycol”. Throughout this specification, the electrolyte which has hard phase and ion conductive phase is also called as “Hard Gel electrolyte”.

Composition

The composition of this invention comprises A) a block copolymer, B) a metal ion and C) a cross-linked polymer comprising polyalkoxide.

(A) Block Copolymer (Matrix Polymer)

The block copolymer used in the inventive composition has both a hard phase and an ion conductive phase, as disclosed in paragraphs 0023-0046 of US2012/0189910A. Therefore, the disclosure of US2012/0189910A is incorporated by reference for describing the block copolymer used in the inventive composition. The block copolymer is also called “matrix polymer” in this specification. The hard phase of the block copolymer contributes mechanical properties of the composition. The ion conductive phase, which is also called “gel phase” herein, contributes to the ion conductivity of the composition. The hard phase is mainly formed from a polymer block having a specific melting temperature or a glass transition temperature (hard component). The ion conductive phase is mainly formed from a block copolymer including a polyalkoxide. The block copolymer is preferably a graft copolymer.

The polymer block which mainly forms the hard phase of the block copolymer has a glass transition temperature (measured for example according to ASTM E1640-99 using dynamic mechanical analysis) or a melting temperature (e.g., a maximum melting temperature or a peak melting temperature measured by differential scanning calorimetry (DSC)) or both greater than 50° C., preferably greater than 60° C., and most preferably greater than 70° C., even more preferably greater than 90° C. The polymer block of the block copolymer has a glass transition temperature, a melting temperature, or both that are less than 250° C., preferably less than 180° C., more preferably less than 160° C.

Examples of the monomer to form the polymer block which has the above final melting temperature or a glass transition temperature include: styrene, methyl methacrylate, isobutyl methacrylate, 4-methyl pentene-1, butylene terephthalate, ethylene terephthalate, and alpha-olefines such as ethylene and propylene. The polymer block of the block copolymer may be homopolymer or co-polymer polymerized from two or more monomers such as described above.

The polymer block that mainly forms the ion conductivity phase of the block copolymer includes a polyalkoxide. The polyalkoxide preferably includes an alkylene oxide having from 2 to 8 carbon atoms. Examples of the polyalkoxide include ethylene oxide, propylene oxide and a copolymer thereof. More preferably, the polyalkoxide is a copolymer including ethylene oxide and propylene oxide.

The block copolymer may be prepared by grafting two or more block polymers. An example of a block of hard component is a copolymer of ethylene and acrylic acid such as Primacor™ 3440 commercially available from The Dow Chemical Company. Examples of a block of polyalkoxide is a polyethylene oxide, polypropylene oxide and copolymer of ethylene oxide and propylene oxide all having one or more of terminal amine(s). Preferably, the block polymer which forms gel phase includes a copolymer of ethylene oxide and propylene oxide having one terminal amine such as Jeffamine M600 commercially available from Hunstman Corporation.

The method for preparing the block copolymer is shown in paragraphs 0047-0049 of US2012/0189910A and it is incorporated in this specification by reference. A typical example of the method for preparing the block copolymer includes the steps of: mixing a copolymer of ethylene and acrylic acid and a copolymer of ethylene oxide and propylene oxide with one terminal amine group at 180° C. for 48 hours under a nitrogen atmosphere to make a grafted block copolymer, pouring the obtained solution into acetone and/or methanol, and washing the grafted block copolymer with methanol via a Soxhlet extractor for 2 days.

(B) Metal Ion

The composition of the present invention comprises a metal ion. The metal ion can exist in the composition as a metal salt. A single salt or a mixture of two or more different salts may be used. Examples of metals of the metal ion include lithium, sodium, beryllium, magnesium or any combination thereof. A particularly preferable metal is lithium. Examples of metal salts include lithium bis-(trifluoromethanesulfonyl)-imide (Li-TFSI), lithium trifluoromethane sulfonate (lithium triflate or LiCF₃SO₃), lithium hexafluorophosphate (LiPF₆), lithium hexafluoroarsenate (LiAsF₆), lithium imide (Li(CF₃SO₂)₂N), lithium tris(trifluoromethane sulfonate) carbide (Li(CF₃SO₂)₃C), lithium tetrafluoroborate (LiBF₄), LiBF, LiBr, LiC₆H₅SO₃, LiCH₃SO₃, LiSbF₆, LiSCN, LiNbF₆, lithium perchlorate (LiClO₄), lithium aluminum chloride (LiAlCl₄), LiB(CF₃)₄, LiBF(CF₃)₃, LiBF₂(CF₃)₂, LiBF₃ (CF₃), LiB(C₂F₅)₄, LiBF(C₂F₅)₃, LiBF₂(C₂F₅)₂, LiBF₃(C₂F₅), LiB(CF₃SO₂)₄, LiBF(CF₃SO₂)₃, LiBF₂(CF₃SO₂)₂, LiBF₃(CF₃SO₂), LiB(C₂F₅SO₂)₄, LiBF(C₂F₅SO₂)₃, LiBF₂(C₂F₅SO₂)₂, LiBF₃(C₂F₅SO₂), LiC₄F₉SO₃, lithium trifluoromethanesulfonyl amide (LiTFSA), or any combination thereof. Combinations of lithium salts may also be used. Similarly, any of the above salts may also be combined with a different salt, such as a different metal salt.

The metal ion is present at a concentration sufficiently high so that the composition has conductivity making it useful as an electrolyte. The concentration of the metal ion in the composition is preferably 0.5 wt % or more, more preferably 1.0 wt % or more, and most preferably 1.5 wt % or more, based on the weight of the polyalkylene oxide phase of the matrix polymer, including the grafted polyalkylene oxide and the cross-linked polymer. The concentration of metal ion in the composition is preferably 30 wt % or less, more preferably 20 wt % or less, and most preferably 15 wt % or less, based on the weight of the polyalkylene oxide phase of the matrix polymer, including the grafted polyalkylene oxide and the cross-linked polymer.

The ratio of the molar concentration of oxygen atoms from the polymer block of gel phase of the block copolymer to the molar concentration of metal ions (O:M ratio) is determined. For lithium ion, the ratio is shown as O:Li ratio. Preferably the O:M ratio is 1:1 or more, more preferably 2:1 or more, even more preferably 4:1 or more, and most preferably 10:1 or more. Preferred electrolyte compositions have an O:M ratio of 120:1 or less, more preferably 80:1 or less, even more preferably 60:1 or less, even more preferably 40:1 or less, and most preferably 30:1 or less. By way of example, the O:M ratio of the electrolyte composition may be about 10, about 15, about 20, or about 25.

(C) Cross-Linked Polymer

The cross-linked polymer of the composition has polyalkylene oxide and is cross-linked each other. The cross-link contributes increasing mechanical strength of the composition while polyalkylene oxide contributes increasing ion conductivity. The cross-linked polymer is formed from the compounds of at least one of the following two groups; the first group (group I) comprises (c-1) cross-linkable compounds having polyalkylene oxide and at least two cross-linkable groups, and the second group (group II) comprises (c-2) compounds comprising polyalkyleneoxide and at least two reactive groups and (c-3) cross-linking agents. It is considered that the cross-linked polymer is located in the ion conductive phase of the matrix polymer, and it reinforces the matrix polymer by its cross-link structure. At the same time, the cross-linked polymer increases ion conductivity of the composition because the cross-linked polymer has polyalkylene oxide.

Not bound to the theory, but it is considered that the block copolymer (matrix polymer) has two phases, i.e., a hard phase and an ion conductive phase, and those are separated into micro areas. When the cross-linkable compound is added in the matrix polymer, the cross-linkable compound is located within the ion conductive phase of the matrix polymer because of the similarity of their polyalkylene oxide structures. Then the cross-linkable compound is polymerized (cross-linked) at the phase. Therefore, the cross-linked polymer is located in the ion conductive phase and reinforces the matrix polymer by its cross-link structure. At the same time, the cross-linked polymer increases ion conductivity of the composition because the cross-linked polymer contains polyalkylene oxide structure so the content of polyalkylene oxide in the composition is increased.

Cross-linkable compounds (c-1) have polyalkylene oxide and at least two cross-linkable groups. Cross-linkable groups of the compounds can form a cross-link by thermal, chemical or photo treatment. Examples of such cross-linkable groups include acrylic acid, methacrylic acid, vinyl groups, glycidyl group, anhydride groups, and isocyanate groups. Polyalkylene oxide of the compounds include polyethylene oxide, polypropylene oxide, co-polymer of ethylene oxide and propylene oxide, oxetane polymer, substituted oxetane polymer, polytetramethylene glycol and substituted polytetramethylene glycol. Preferable polyalkylene oxides are polyethylene oxide, polypropylene oxide and co-polymer of ethylene oxide and propylene oxide. Examples of cross-linkable compounds (c-1) include polyethylene glycols diacrylate (PEGDA), polyethylene glycols dimethacrylate (PEGDMA), vinyl terminated polyethylene glycols, acrylate terminated polydimethylsiloxanes, methacrylate terminated polydimethylsiloxanes and vinyl terminated polysiloxanes.

Molecular weight of the cross-linkable compounds is not limited, but preferably the weight average molecular weight (Mw) is 100 or more, more preferably 200 or more. The Mw of the cross-linkable compounds is preferably 20,000 or less, more preferably 10,000 or less. Examples of the cross-linkable compounds having the preferable Mw include, PEGDA 258, PEGDA 400, PEGDA 575 and PEGDA 700 all products is available from Aldrich.

The compounds described as (c-2) is a compound comprising polyalkylene oxide and at least two reactive groups. The compounds of this group cannot be self polymerized (cross-linked). Polyalkylene oxides of the compounds are same as the one of the cross-linkable compounds (c-1) disclosed above. Examples of the reactive groups of the compounds (c-2) include epoxide groups, amine groups, hydroxyl groups, anhydride groups and isocyanate groups. Examples of the compounds (c-2) include styrene-maleic anhydride copolymer (SMA), polyethylene glycols diglycidyl ether (PEGDE), polyethylene glycols amines, polyethylene glycols-polypropylene oxide copolymer amines, polyethylene glycols and polyethylene oxide and siloxane copolymers.

Mw of the compounds (c-2) is not limited, but preferably 100 or more, more preferably 200 or more. Mw of the compound (c-2) is preferably 20,000 or less, more preferably 10,000 or less. Examples of the compounds (c-2) include Dowfax™ 600, D.E.R.™ 732, Jeffamine™ ED900 and Dow Corning® 29 additive.

The cross-linking agents described as (c-3) can be polymerized (cross-linked) with the compounds (c-2). Examples of the cross-linking agents (c-3) include polyetheramine, polyethylene oxide diamine, hexamethylene diisocyanate, 4,4′-methylenediphenyldiisocyanate, hexamethylene diisocyanate trimmer, diethylenetriamine, triethylenetetramine, imidazole and methylimidazole. Examples of commercially available cross-linking agents include Jeffamine™ ED600, Jeffamine™ ED900, Desmodur® N3300, D.E.H™ 20 and D.E.H™ 24.

For both cases a cross-linked polymer is formed from group I or II, the cross-link is formed after cross-linkable compounds (c-1) or a polyalkoxide (c-2) are added in the block copolymer (A). The content of the cross-linked polymer is preferably 5 wt % or more, more preferably 10 wt % or more based on the weight of the block copolymer. The content of the cross-linked polymer is preferably 500 wt % or less, more preferably 400 wt % or less based on the weight of the block copolymer.

As shown later, if a cross-link is not formed in the ion conductive phase of the matrix polymer, mechanical strength of the matrix polymer would be decreased. In contrast, if a crosslinkable compound which does not have polyalkoxide structure is used instead of the crosslinkable compound used in the inventive composition, it would increase mechanical strength but decrease ion conductivity because the content of polyalkylene oxide in a matrix polymer is decreased.

Solvent

The composition of the present invention may further comprise a solvent. The solvent is preferably an organic solvent. A preferred solvent includes cyclic carbonates, acyclic carbonates, fluorine containing carbonates, cyclic esters or any combination thereof. More preferably, the solvent is carbonates including cyclic, acyclic and fluorine containing carbonates or mixture thereof. Examples of such carbonates include ethylene carbonate (EC), propylene carbonate (PC), fluoroethylene carbonate (FEC), butylenes carbonate (BC), dimethyl carbonate (DMC), ethylmethyl carbonate (EMC), diethyl carbonate (DEC), dipropyl carbonate (DPC), methylpropyl carbonate (MPC), ethyl propyl carbonate (EPC), methylbutyl carbonate, vinylene carbonate (VC), vinylethylene carbonate (VEC), divinylethylene carbonate, phenylethylene carbonate, diphenylethylene carbonate, difluoroethylene carbonate (DFEC), bis(trifluoroethyl) carbonate, bis(pentafluoropropyl) carbonate, trifluoroethyl methyl carbonate, pentafluoroethyl methyl carbonate, heptafluoropropyl methyl carbonate, perfluorobutyl methyl carbonate, trifluoroethyl ethyl carbonate, pentafluoroethyl ethyl carbonate, heptafluoropropyl ethyl carbonate, perfluorobutyl ethyl carbonate and any combination thereof. Among these solvents, EC and PC are preferred, and PC is the most preferred.

The concentration of the solvent including carbonates is preferably 30 wt % or more, more preferably 35 wt % or more based on the total weight of the composition.

Other Additives

The composition of the present invention may further comprise other additives. Examples of such additives include inorganic filler and ionic liquid. Inorganic filler increases the mechanical strength of the composition, and ionic liquid increases the ion conductivity of the composition. Examples of inorganic filler include SiO₂, ZrO₂, ZnO, CNT (carbon nanotube), TiO₂, CaCO₃, Al₂O₃ and B₂O₃. Examples of ionic liquid include 1-allyl-3-methylimidazolium chloride, Tetraalkylammonium Alkylphosphate, 1-ethyl-3-methylimidazolium propionate, 1-methyl-3-methylimidazolium formate and 1-propyl-3-methylimidazolium formate.

When inorganic filler is used, the content of the inorganic filler is preferably 0.1 wt % or more, more preferably 0.5 wt % or more, the most preferably 1 wt % or more based on the weight of matrix polymer. The content of the inorganic filler is preferably 100 wt % or less, more preferably 50 wt % or less, the most preferably 30 wt % or less based on the weight of matrix polymer.

Method for Making Composition

Two methods to make the composition of this invention are broadly described as follows. The first method (method I) comprises the steps of (1) preparing a solution comprising a matrix polymer, (2) adding (c-1) cross-linkable compounds having polyalkylene oxide in the solution and (3) cross-linking the cross linkable compounds. The metal ion source such as metal salt is typically added later.

For the method I, the above disclosed matrix polymer can be used. During the steps, any solvent can be used as long as it can dissolve the matrix polymer. Examples of solvents include toluene, xylene, dimethyl formamide, DMF, dimethylsulfoxide, DMSO and tetrachloroethane.

The matrix polymer solution can be stirred before and after the cross-linkable compound is added. As described above, the cross-linkable compound having an alkylene oxide is generally located in the ion conductive phase of the matrix polymer.

The cross-linkable compound in the mixture is then cross-linked by thermal, chemical or photo treatment. Subsequently, the metal ion source is added. A solvent such as a carbonate may be then be added if desired.

A typical example of method I comprises: dissolving a matrix polymer in toluene at 60° C., adding a cross-linkable compound (c-1) in the toluene solution, stirring it at 60° C. for 30 minutes, pouring the mixture on a PTFE plate, heating the mixture at 80° C. to form cross-link and remove toluene, immersing the solid membrane in a propylene carbonate (PC) solution with lithium ions, and incubating them for 6 hours.

The second method (method II) comprises the steps of: (1) preparing a solution comprising a matrix polymer, (2) adding (c-2) compounds comprising polyalkoxide and at least two reactive groups in the solution, (3) adding (c-3) cross-linking agents and (4) cross-linking the compounds comprising polyalkoxide with a cross-linking agent. Subsequently, the metal ion source is added.

For method II, the same matrix polymer and solvent may be used as in method I. The compound disclosed as (c-2) is added and mixed with the solution comprising a matrix polymer. After that, cross-linking agent (c-3) is added. The cross-linking agent (c-3) reacts with reactive groups of the compound comprising polyalkoxide and at least two reactive groups (c-2). The metal ion source is then added. A solvent such as a carbonate may be added if desired.

A typical example of method II is comprises; dissolving a matrix polymer in toluene at 60° C., adding a compound (c-2) in the toluene solution, mixing it at 60° C. for 30 minutes, adding a cross-linking agent (c-3) in the mixture under stirred, pouring the mixture on PTFE plate, heating the mixture at 80° C. to form cross-link and remove toluene, immersing the solid membrane in a propylene carbonate (PC) solution with lithium ions, and incubating them for 6 hours.

Electrolyte and Battery

The composition of this invention may be used as an electrolyte in a secondary battery cell including at least one anode, at least one cathode, one or more current collectors, and optionally a separator, all in a suitable housing. Especially, the composition of this invention may be used as a solid polymer electrolyte which has less risk of leakage of liquid electrolyte.

Also, the composition of this invention may be used as an electrolyte in a battery for providing power to an electrical device. The electrolyte comprising the composition may be advantageously used in a battery for providing power to a mobile device, such as a cell phone, a vehicle, a portable device for recording or playing sound or images such as a camera, a video camera, a portable music or video player, a portable computer and the like.

### EXAMPLES

### Inventive Example 1

### Method I

Preparation of Block Copolymer (Matrix Polymer)

A graft copolymer having a copolymer of ethylene and acrylic acid (EAA) backbone and alkoxide grafts attached by an amide linkage was prepared by grafting Jeffamine™ M600 (available from HUNTSMAN CORPORATION) onto Primacor™ 3440 (available from THE DOW CHEMICAL COMPANY). 20 g of Primacor™ 3440 and 56.5 g of Jeffamine M600 were molten mixed at 180° C. under a nitrogen blanket by stirring for about 48 hours. The molar ratio of amine groups (—NH₂) to carboxylic acid groups (—COOH) was 3.5:1. The melt was then poured into stirred methanol. The polymer was then cut into small pieces and washed with methanol via a Soxhlet extractor apparatus for 2 days. Next, the polymer was dried in vacuum overnight at about 70° C. The obtained polymer was pressed into a film and was characterized by FT-IR, DSC and proton NMR. The DSC indicated that the graft copolymer had a melting temperature of about 100° C. and a heat of fusion of about 31 J/g. The Proton NMR analysis was expected to indicate that the concentration of the ethylene oxide-propylene oxide grafts was about 40.1 weight percent based on the total weight of the graft copolymer. Comprehensive 2D NMR and ¹³C NMR were used for the signal assignments and the results indicated that the poly(ethylene oxide-co-propylene oxide) graft was attached to the EAA by an amide linkage. Newly formed amide proton in grafted polymer was presented at around 5.7 ppm. The grafted mole ratio was calculated according to divided the total carbonyl carbons at 176 ppm by amide branching carbon at 49 ppm in the 13C NMR spectrum. The calculation showed that about 76 mole percent of carboxylic acid in Primacor was converted to the amide by reacting with Jeffamine.

Preparation of Electrolyte Film

The above prepared matrix polymer 10 g was dissolved in 200 ml of toluene at 60° C. Polyethylene glycols diacrylate (PEGDA) (Mw is 575, available from Aldrich) was added to the toluene solution at 60° C. for 30 minutes. The amount of PEGDA575 was 100 wt % based on the matrix polymer. The mixture was poured on PTFE plate and heated at 80° C. for 4 hours. A film was obtained on the PTFE plate. The film was then dried in vacuum oven at 80° C. overnight. The dry film with thickness of 100 μm was obtained. The film was cut into specimens with diameter of 18 mm. The samples were immersed in propylene carbonate (PC) with lithium bis-(trifluoromethanesulfonyl)-imide (LiTFSI) (LiTFSI/PC=1/24) and incubated for 4 hr. The obtained polymer electrolytes were ready of performance evaluation. Results are shown in Table 1.

Test Methods

1. Ion Conductivity

The ion conductivity of the polymeric electrolyte compositions was measured using AC impedance spectroscopy in Princeton 2273 using alternating current (AC) amplitude of about 10 mV. Details of the AC impedance spectroscopy method are in Handbook of Batteries, 3rd Ed; David Linden and Thomas Reddy, Editors, McGraw-Hill, 2001, New York, N.Y., pp. 2.26-2.29, incorporated herein by reference.

2. Storage Modulus (G′)

Storage modulus is used to characterize the mechanical strength of an electrolyte. Storage modulus of the polymers and of the polymeric electrolyte compositions were measured using dynamic mechanical analysis (e.g., according to ASTM D5279-08). Unless otherwise specified shear modulus is measured at a temperature of about 30° C. and a oscillatory shear frequency of about 6.28 radian/sec at a strain of typically about 0.04 percent.

### Inventive Examples 2-8 and Comparative Examples 1 and 2

Inventive Examples 2-8 and Comparative Examples 1 and 2 were conducted in the same way as Inventive Example 1 except that the crosslinkable compound or its amount of Inventive Example 1 was changed as shown in Table 1. Table 2 shows crosslinkable compound used in those examples and its abbreviation. Jeffamine M600 used in Comparative Example 2 cannot form cross-link because there is not crosslinkable group. The results are shown in Table 1.

### Inventive Examples 9-11

Inventive Examples 9, 10 and 11 were conducted in the same way as Inventive Example 1 except that 0.5 g of SiO₂ (supplied from Aldrich), TiO₂ (supplied from Aldrich) and ZrO₂ (supplied from Aldrich) were further added respectively when PEGDA 575 was added. The results are shown in Table 1.

TABLE 1

| | | | | | | Mechani- |
|---|---|---|---|---|---|---|
| | Crosslinkable | | Inorganic | | Ion | cal |
| | compounds | | fillers | | conductivity | strength |
| Ex. | | Amount | | Amount | (×10⁴, | (×10⁶, |
| No. | | (%)*¹ | | (%)*¹ | S/cm) | Pa) |
| In. 1 | PEGDA 575 | 100 | | | 8.7 | 2.6 |
| In. 2 | PEGDA 575 | 50 | | | 5.2 | *³ |
| In. 3 | PEGDA 700 | 100 | | | 5.6 | *³ |
| In. 4 | PEGDA 700 | 50 | | | 5.4 | *³ |
| In. 5 | PEGDA 400 | 100 | | | 5.6 | *³ |
| In. 6 | PEGDA 400 | 50 | | | 4.7 | *³ |
| In. 7 | PEGDA 258 | 100 | | | 8.6 | *³ |
| In. 8 | PEGDA 258 | 50 | | | 6.0 | *³ |
| In. 9 | PEGDA 575 | 100 | SiO₂ | 5 | 10.2 | *³ |
| In. | PEGDA 575 | 100 | TiO₂ | 5 | 8.5 | *³ |
| 10 | | | | | | |
| In. | PEGDA 575 | 100 | ZrO₂ | 5 | 8.3 | *³ |
| 11 | | | | | | |
| Co. 1 | —*² | — | | | 2.5 | 2.1 |
| Co. 2 | Jeffmine | 100 | | | 8.5 | 1.0 |
| | M600 | | | | | |

*¹amount (%) means weight % based on the total weight of matrix polymer.
*²Comparative Example 1 was not added any oligomer or polymer.
*³: Mechanical strength of Inventive Examples 2-11 were not measured because increased mechanical strength is easily expected.

TABLE 2

| | | Mw |
|---|---|---|
| PEGDA575 | polyethylene glycols diacrylate | 575 |
| PEGDA700 | polyethylene glycols diacrylate | 700 |
| PEGDA400 | polyethylene glycols diacrylate | 400 |
| PEGDA258 | polyethylene glycols diacrylate | 258 |

All chemicals were supplied from Aldrich.

### Inventive Example 12

### Method II

Inventive Example 12 is an example of a cross-linked polymer formed by (c-2) compound comprising polyalkylene oxide and at least two reactive groups and (c-3) crosslinker.

Polymer matrix was prepared same as Inventive Example 1.

10 g of Polymer matrix was dissolved in 200 ml of toluene at 60° C. 0.89 g of styrene-maleic anhydride copolymer (SMA) (SMA 40, molar ration of styrene to maleic anhydride is 4:1, M_{W} is 10,500, available from Sartomer Company) was added to the toluene solution at 60° C. and stirred for 20 minutes. The amount of SMA was 8.9 wt % based on the matrix polymer. Jeffamine ED900 (polyalkylene amine having two terminal amines, Mw is about 900, available from HUNSMAN) was added and further stirred at 60° C. for 20 minutes. The mixture was poured on PTFE plate and heated at 80° C. for 4 hours. A film was obtained on the PRFE plate. The film was then dried in vacuum oven at 80° C. overnight. The dry film with thickness of 150 μm was obtained. The film was cut into specimens with diameter of 18 mm. The samples were immersed in propylene carbonate (PC) with lithium bis-(trifluoromethanesulfonyl)-imide (LiTFSI) (LiTFSI/PC=1/24) and incubated for 4 hr. The obtained polymer electrolytes were ready for performance evaluation. Results are shown in Table 3.

### Inventive Examples 12-14

Inventive Examples 12-14 were conducted same as Inventive Example 12 except for SMA, Jeffamine ED900 and those amounts were changed as shown in Table 3. For Inventive Examples 13 and 14, 1 g of SiO₂ was further added when polyalkylene compounds were added. Jeffamine ED900 is a polyether diamine based on 70 mole percent ethylene oxide and 30 mole percent propylene oxide available from HUNTSMAN CORPORATION, and its Mw is 900. Dowfax 600 is polyalkylene oxide having two terminalaepoxides supplied from The Dow Chemical Company. Dow Corning 29 is a block copolymer of ethylene oxide and dimethylsiloxane with two hydroxyl groups as terminal groups available from THE DOW CORNING CORPORATION and its Mw is about 2,200 g/mole. Desmodur N3300 is hexamethylene diisocyanate trimmer available from BAYER CORPORATION and has an isocyanate group weight of 21.8%. Results are shown in Table 3.

TABLE 3

| | Polyalkylene | | | | Inorganic | | Ion | Mechanical |
|---|---|---|---|---|---|---|---|---|
| | compounds | | crosslinker | | filler | | conductivity | strength |
| Ex. | | Amount | | Amount | | Amount | (×10⁴, | (×10⁶, |
| No. | | (%) | | (%) | | (%) | S/cm) | Pa) |
| In. | SMA | 8.9 | Jeffamine | 11.1 | | | 6.1 | 2.6 |
| 12 | | | ED900 | | | | | |
| In. | SMA | 17.8 | Jeffamine | 22.2 | | | 8.5 | 2.1 |
| 13 | | | ED900 | | | | | |
| In. | DOWFAX600 | 100 | Methylimidazole | 6 | SiO₂ | 10 | 8.3 | 1.8 |
| 14 | | | | | | | | |
| In. | Dow | 100 | Desmodur | 17 | SiO₂ | 10 | 7.3 | 2.1 |
| 15 | corning 29 | | N3300 | | | | | |

1. A composition comprising
A) a block copolymer comprising
i) a polymer block having a final melting temperature greater than 60° C. or a glass transition temperature greater than 60° C., and
ii) a polymer block including a polyalkoxide;
B) a metal ion; and
C) a cross-linked polymer comprising polyalkoxide.

2. The composition of claim 1, wherein the cross-linked polymer (C) is formed from (c-1) a cross-linkable compound having polyalkoxide and at least two cross-linkable groups.

3. The composition of claim 2, wherein the cross-linkable groups of the cross-linkable compound (c-1) are selected from the group consisting of acryl group, methacryl group and glycidyl group.

4. The composition of claim 1, wherein the cross-linked polymer (C) is formed from (c-2) a compound comprising polyalkoxide and at least two reactive groups and (c-3) a cross-linking agent.

5. The composition of claim 4, wherein the cross-linking agent (c-3) is selected from hexamethylene diisocyanate, 4,4′-methylenediphenyldiisocyanate, hexamethylene diisocyanate trimmer, diethylenetriamine, triethylenetetramine, imidazole, methylimidazole and polyethyramine.

6. The composition of claim 1, wherein the metal ion is lithium ion.

7. The composition of claim 1, wherein the composition further comprises carbonates.

8. The composition of claim 1, wherein the composition further comprises an inorganic filler.

9. A solid polymer electrolyte comprising the composition of claim 1.

10. A secondary lithium battery comprising the solid polymer electrolyte of claim 9.

11. A method for making a composition of claim 1, comprising the steps of:
(1) preparing a solution comprising a block copolymer of (A),
(2) adding the cross-linkable compound (c-1) in the solution, and
(3) cross-linking the cross-linkable compound.

12. A method for making a composition of claim 1, comprising the steps of:
(1) preparing a solution comprising a block copolymer of (A),
(2) adding a compound comprising polyalkoxide and at least two reactive groups (c-2) in the solution,
(3) adding a doss-linking agent (c-3) in the solution, and
cross-linking (c-2) with (c-3).
